(19) United States
(12) Patent Application Publication
(10) Pub. No.: US 2022/0105749 A1
(43) Pub. Date: Apr. 7, 2022

(54) MECANUM WHEELS APPLIED TO THE SYSTEM FOR MOVING A SUSPENDED MOBILE PLATFORM ON VERTICAL AND HORIZONTAL FLAT SURFACES

(71) Applicants: PETROLED BRASILElRO S.A. - PETROBRAS, Rio de Janeiro (BR); SERVICO NACiONAL DE APRENDIZAGEM INDUSTRIAL - DEPARTAMENTO REGIONAL DE SANTA CATARiNA, Florianopolis (BR)

(72) Inventors: Andre KOEBSCH, Rio de Janeiro (BR); Ariel Paulo REZENDE, Joinville (BR); Andre MARCON ZANATTA, Joinville (BR); Ismael Jose SECCO, Joinville (BR); Walter KARP, Curitiba (BR)

(21) Appl. No.: 17/419,012

(22) PCT Filed: Dec. 19, 2019
(86) PCT No.: PCT/BR2019/050555

§ 371 Date: Jun. 28, 2021

(30) Foreign Application Priority Data
Dec. 28, 2018 (BR) BR1020180773801

(51) Int. Cl. B60B 19/00; B60B 19/12

(52) U.S. Cl. CPC B60B 19/003; B60B 2900/351; B60B 19/12

(57) ABSTRACT

The present invention relates to the construction of Mecanum wheels for a robot-operated painting system. The wheels have special characteristics given the difficulties and obstacles where they will be used. They were designed to facilitate the movement of the painting system on vertical and horizontal walls and to avoid coating losses. The Mecanum wheels consist of a set of wheel covers that are used to secure the rollers. The rollers, arranged at 45° and in a cylindrical-convex shape, contain bearings passing through their central axis, and have rollers at the ends of the bearings. The magnetic base is placed between the two wheels, being at an optimal height to exert magnetic force against the surface and to be able to pass over obstacles. Mecanum wheel geometries and materials are designed to be inert to the coating.

### FIELD OF THE INVENTION

The present invention refers to technologies for ship and oil platform equipment, in addition to building maintenance. More specifically, the present invention relates to robot-automated painting technology.

### BACKGROUND OF THE INVENTION

Large flat vertical surfaces are currently maintained or inspected by means of building access, such as using climbing harnesses or scaffolding. In order to paint, an employee must be able to access the location to be painted.

In shipbuilding, access is by scaffolding, as the work is done in dry dock. This access is financially expensive and time-consuming. Furthermore, it involves work safety risks.

To inspect or paint large areas, various technologies for movement may be employed, such as carts with magnetic wheels, paddle systems with suction cups, and rail installation in parts, among other solutions. These solutions are time-consuming and ineffective when using a painting system.

There is a need to reproduce the type of painting done by an employee. This means that there are certain variables to consider in performing the work. One of these is the linear manner in which the painting system applies paint. The movement of an employee that is considered to be the most effective is usually rectilinear (horizontal or vertical), stopping application at the ends. Since the speed in the inversion of movement is zero at these endpoints, the painting system could overspray. To prevent overspray, the mechanism of the paint application gun is stopped until it returns to its normal application speed.

Several technologies for mobile inspection of metal surfaces may be used, such as the use of carts with magnetic wheels, paddle systems with suction cups, installation of rails on the parts, among other solutions.

Document U.S. Pat. No. 3,876,255A discloses a wheel design with bearings that have an angle of approximately 45° with respect to the wheel axis. It has an open side structure where the rollers are exposed to the coating, which can be damaged with its entry, consequently causing the wheel to lock. Therefore, the model does not meet the stipulated requirements for it to be used in a painting system in which the wheels come into contact with the coating. Furthermore, regarding the adopted roller model, it has a structure with a central bearing, making it even less suitable for use in painting systems.

Tavakoli et al. (Magnetic Omnidirectional Wheels for Climbing Robots) reveals omnidirectional magnetic wheels adapted for movement in 3D ferromagnetic structures, such as vertical walls and ceilings. The magnets are arranged on the periphery of the wheels and follow their movement.

As the magnets are not fixed and remain parallel to the contact surface at all times, we can identify a variation in magnetic force during the vehicle's movement, considering the geometric and constructive factors, which implies difficulty in using painting systems because it impacts the homogeneity of the coating to be applied.

As will be further detailed below, the present invention aims to solve the problems of the state-of-the-art described above in a practical and efficient manner.

### SUMMARY OF THE INVENTION

The approach in this application is aimed at painting large vertical walls and consists of using a suspended mobile platform on controlled cables, allowing a large surface area to be covered using a lightweight modular infrastructure.

The suspended mobile platform is positioned by the cables, with its suspension system placed on free Mecanum wheels that act like spheres. Additionally, the wheels are provided with a proximity magnet system, which allows the device not to move away from the metal wall; the magnets in turn do not contact the surface of the metal wall, ensuring they do not damage the surface. This same principle applies to the rollers comprising the wheels, which are constructed of a material and have a geometrical design that prevents the surface from being damaged.

Various technologies for movement may be employed, such as carts with magnetic wheels, paddle systems with suction cups, and rail installation in parts, among other solutions.

The proposed system of Mecanum wheels must consider the following issues: clear irregular surfaces, be capable of moving along x and y coordinates (Cartesian plane), not impact the painted surface by using polymeric components in the rollers.

On uneven surfaces, furthermore, the wheels must cross side weld seams up to 3 mm wide in any direction. Because the magnets are away from the contact surface, it is possible to move over obstacles that are up to 10 mm in height, ensuring that the device can pass over any unevenness on side surfaces, including obstacles such as screws and weld beads, ensuring that the magnetic force continues to act on the surface.

Roller bearings allow for washing after coming into contact with the coatings.

The wheels do not require lubrication due to the use of shielded external weather-resistant bearings.

The movement speed must be such that it meets a minimum process speed. This minimum speed may be around 105 m² per hour.

The wheels together with the system were designed to minimize coating losses during the painting process. The wheels are designed so that fresh paint does not get inside them. And after curing, the wheels do not damage the coating that was applied.

The strategy used in the painting process is not to paint while descending, and to paint while ascending, such that the main obstacles will be faced in the process, as if descending stairs. Shifting to a side section will occur at the top of the hull when the ropes are very taut, and therefore momentum will be tightly controlled. There is no interference from the obstacles during painting. The movement of the mobile platform is independent of obstacles. The movement is mainly related to not passing over a newly painted region. The robot was developed to pass over obstacles without interfering with the painting.

The wheels feature a set of magnets arranged in a line under a central base and parallel to the surface where movement will occur.

In addition to the oil and gas industry, this technology may be used in civil construction.

### BRIEF DESCRIPTION OF THE FIGURES

The detailed description presented below references the attached figures and their respective reference numbers.

FIG. 1 details the arrangement of magnets and rollers.

FIG. 2 shows the arrangement of rollers, bearings and the cylindrical shape of the wheel.

FIG. 3 shows the wheels fitted to the platform, where the assembly adapts to different surface curvatures.

FIG. 4 shows examples of surfaces with irregularities with the proposed adapted wheel system.

FIG. 5 shows the robotized paint assembly in which the wheel system (mobile platform) is used.

### DETAILED DESCRIPTION OF THE INVENTION

The objective of the present invention is to adopt a characteristic type of wheel to be applied to a robotized painting system, with the main characteristics of high reliability, capacity to move very quickly, resistance to the type of coating applied, low need for lubrication of the bearings, good ability to pass over irregularities and obstacles on the surface and not be affected (be resistant) by the painting process, including the paint from the application process, making the wheels resistant to fresh paint.

In order to achieve the objectives described above, the present invention provides a set of magnets arranged in line under a central base and parallel to the surface where movement will take place. Wheels behave like spheres.

Additionally, the wheels are provided with a proximity magnet system, which allows the device not to move away from the metal wall; the magnets in turn do not contact the surface of the metal wall, ensuring they do not damage the surface. This same principle applies to the rollers comprising the wheels, which are constructed of a material and have a geometrical design that prevents the surface from being damaged.

Regarding the ability to pass over obstacles, as the magnets are away from the contact surface, it is possible to move over obstacles that are up to 20 mm in height, ensuring that the device can pass over any unevenness on side surfaces, including obstacles such as screws and weld beads, ensuring that the magnetic force continues to act on the surface.

A preferred embodiment of the invention will be presented below. As will be apparent to anyone skilled in the art, however, the invention is not limited to that particular embodiment.

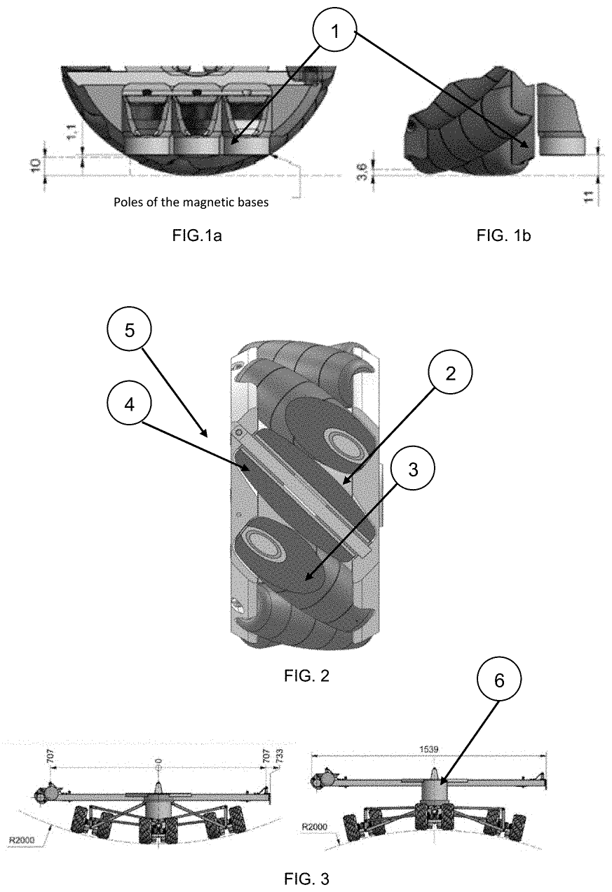

The magnetic base (1) is located between two wheel covers (2). The poles of the magnetic base are pointed directly at the surface where the contact is made by the wheels, directly on the rollers (3). Thus, the magnetic force is uniform, does not depend on the rollers (3) and there is no contact with the surface. The rollers (3), in turn, are arranged in several units along the wheel cover (2), preferably placed at 45°, but they are not limited to this layout. The rollers (3) are hollow inside, allowing the use of bearings (4) and preventing the bearings from being impacted by coating entering in. Figure la details the magnetic base coupled to one of the wheel covers (2). FIG. 1b details the rollers, in a cylindrical shape along its body, but with a variable diameter, with a larger diameter in the center and a smaller diameter on the sides. Thus, the shape of the roller (3) along its body is convex in the direction of contact with the surface.

The same FIGS. 1a and 1b, show the ability to pass over obstacles that are parallel up to 10 mm and perpendicular to the wheel axles up to 3.6 mm. The obstacle could be bigger, but it is limited by the magnetic bases, which have an expected height of 20 mm, resulting in a clearance of 1 mm. Thus, the height limit is not on the wheel covers (2) or rollers (3), but on the height of the magnetic base.

The height of the magnetic base, which may be adjusted depending on the need for more adherence, is determined by the trade-off between clamping force and the risk of blocking in the event it has to pass over or avoid a collision. If the poles have zero air gaps, the force would be too great, which could block the robot's descent. In this case, therefore, the assembly would only have traction from the weight. Thus, in order to have this characteristic of being able to pass over obstacles, the diameter of the wheels, which was initially 100 mm, increases to 172 mm, but they are not limited to this specific size.

FIG. 2 shows the rollers (3) arranged at 45° between the wheel covers (2). The rollers (3) are hollowed for the passage of the bearings (4). The rollers are free of bearings (5). The wheel covers (2) are hollowed to receive the rollers (3) with fastening for screws. The bearings (5) are insulated (shielded) on the wheels and thus are unaffected by contact with the paint coating. The wheel covers (2) are like the hubcaps on a vehicle that do not come into contact with the surface and that serve to support the rollers (3).

FIG. 3 shows the wheel assembly (Mecanum wheels) attached to the mobile platform (6), designed to cushion and adjust to surface deformities. The radius of curvature where the mobile platform is used is around 2000 m, fully designed according to the characteristics of the Mecanum wheels.

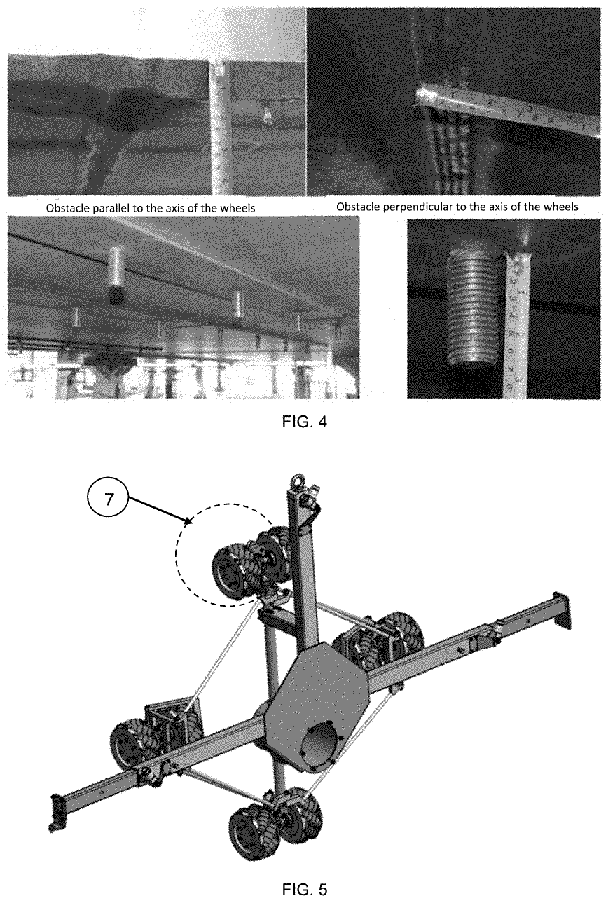

FIG. 4 shows lines of obstacles that the wheels must be able to pass over. The biggest “steps” are the variations of plates on the hull, always horizontal lines, which in the design of the replicating platforms are on the external surface of the hull, precisely the one that will be painted. The decrease in thickness is always at the bottom of the hull to the first uncovered deck. Other steps of lower height are the weld beads, which go in all directions. The strategy used so that obstacles disturb the painting process as little as possible is not paint while descending, and to paint while ascending.

FIG. 5 shows a mobile platform (6) attached to the painting platform, serving as an example of use of the mobile platform (6), but not restricted to operating only with the painting platform. The set of Mecanum wheels (7), connected to the mobile platform, is shown, usually around four “4.” The mobile platform is being claimed in another patent application.

We inform you that the use of Mecanum wheels is not restricted to the embodiment shown here, as they may be used in any application.

1. A mecanum wheel used in a system for moving a suspended mobile platform on vertical and horizontal flat surface, the mecanum wheel comprising:
a magnetic base;
wheel covers;
rollers;
conveyors; and
bearings.

2. A mecanum wheel of claim 1, wherein the rollers are connected through the bearings in the wheel covers and offset by 45 degrees.

3. A mecanum wheel of claim 1, wherein the rollers have a cylindrical shape and a convex base, and comprise a material that is inert to a wall coating.

4. A mecanum wheel of claim 1, wherein the rollers are hollow for passage of the bearings, and the rollers are devoid of contact with the bearings.

5. A mecanum wheel of claim 1, wherein the bearings are fitted into the wheel covers to protect the bearings from external contamination.

6. A mecanum wheel of claim 1, wherein the wheel covers have an adjusted format for inserting the rollers without interference, a hole for inserting the bearings and a support for the magnetic base.

7. A mecanum wheel of claim 1, further comprising:
two wheel covers;
the magnetic base containing three magnetic elements;
twelve rollers; and
one of the bearings for each of the rollers.

8. A mecanum wheel of claim 1, further comprising:
two wheel covers;
the magnetic base containing three magnetic elements;
twelve rollers; and
two rollers per bearing.

9. A mecanum wheel of claim 1, wherein the wheel covers are hollowed to receive the rollers with screws and the wheel covers are coupled with the magnetic base.
